(19) United States
(12) Patent Application Publication
(10) Pub. No.: US 2009/0303388 A1
(43) Pub. Date: Dec. 10, 2009

(54) PICTURE DISPLAY DEVICE

(75) Inventors: Ichiro YAMADA, Kobe-shi (JP); Takafumi HAYASHI, Osaka-shi (JP)

Correspondence Address: NOVAK DRUCE + QUIGG LLP, 1300 EYE STREET NW, SUITE 1000 WEST TOWER, WASHINGTON, DC, 20005, US

(73) Assignee: SANYO ELECTRIC CO., LTD., Osaka (JP)

(21) Appl. No.: 12/477,620

(22) Filed: Jun. 3, 2009

(30) Foreign Application Priority Data
Jun. 5, 2008 (JP) 2008-148217

(51) Int. Cl. H04N 9/74; H04N 5/66

(52) U.S. Cl. 348/581; 348/739; 348/E05.133

(57) ABSTRACT

A picture display device for displaying a picture includes a setting unit, which enables a setting of a function related to the picture display device, such as a function for adjusting the size of a picture, to be changed. The setting unit determines whether or not to initialize the setting of the function when the power is switched between ON and OFF.

### CROSS-REFERENCE TO RELATED APPLICATIONS

This application is based upon and claims the benefit of priority from the prior Japanese Patent Application No. 2008-148217, filed on Jun. 5, 2008, the entire contents of which are incorporated herein by reference.

### BACKGROUND OF THE INVENTION

The present invention relates to picture display devices, such as televisions, used in homes and other facilities.

It is known in the art that a picture display device such as a television has functions of which settings may be changed by a user (i.e., person using the picture display device). For example, a user may change in accordance with his or her preferences the setting of a function that adjusts the size of a picture shown on a display and the setting of a function that adjusts the volume of the sound reproduced by a speaker.

The setting of a function for adjusting the size of a picture (i.e., screen size) may be changed as shown in FIGS. 1 and 2 so as to enlarge a picture P, which is shown on a display 107, as indicated by arrows E. In other words, as shown in FIG. 1, when the display 107 has an aspect ratio of 16:9 and the picture P shown on the display 107 has an aspect ratio of 4:3, the setting of a function for adjusting the size of the picture P is changed to enlarge the picture P so that the width of the picture P becomes the same as the display 107. Similarly, as shown in FIG. 2, when the display 107 has an aspect ratio of 16:9 and the picture P shown on the display 107 has an aspect ratio of 2:1, the setting of a function for adjusting the size of the picture P is changed to enlarge the picture so that the height of the picture P becomes the same as the display 107. When each picture P is enlarged as shown by arrows E in the drawings, the part of the picture E shown by hatching lines are cut out and not shown on the display 107.

In a picture display device of which the setting of a function is changeable as described above, the setting contents are normally stored in a non-volatile memory such as an EEPROM so as to hold the settings of the function even if the power is switched between ON and OFF. In other words, in a picture display device in which the setting of the function for adjusting the size of a picture is changeable, the setting contents are stored in an EEPROM. Thus, even if the power is switched between ON and OFF, the function for adjusting the picture size operates under the settings determined before the power went OFF. To switch the power between ON and OFF, a power supply plug of the picture display device may be connected to and disconnected from AC outlet, a power switch of the picture display device may be turned ON and OFF, and the power button of the remote controller may be turned ON and OFF.

Picture display devices that hold the setting of a function as described above are not only used as household appliances but also used for commercial purposes, such as in guest rooms of lodging facilities. In such a case, a picture display device exhibits a function of which a user may not be aware. More specifically, when the picture display device is used for commercial purposes, users are unknown. Thus, if a certain user changes the setting of a function and the setting is held, another user would not be aware of the function setting. Therefore, for example, when a picture display device has a function for changing the setting that adjusts the size of a picture and a certain user changes the setting to enlarge the picture, this may result in another user viewing a partially cutout picture on the display. In such a case, this user may determine that the picture display device is not functioning properly and make a complaint.

Accordingly, the held settings of a function may be initialized. For example, when accepting an initialization instruction from a user, a menu screen shown on a screen may include a message prompting for the selection of either one of complete initialization or partial initialization. Values that were changed are initialized in accordance with the selection.

However, with such a picture display device, the setting of the function is initialized in accordance with a user instruction. Therefore, the user must be aware that the function setting needs to be initialized. In other words, the function setting cannot be initialized unless the user is aware of such need.

To initialize a function setting without a user having to be aware of such need, a picture display device that does not hold and store the contents of a setting may be used. However, such a picture display device would be inconvenient if the same user were to continuously use the display device since the function setting changed in accordance with the user's preferences cannot be held. Accordingly, it is difficult to initialize the setting of a function in accordance with who the user is while initializing the function setting without the need for the user being aware of such initialization.

### SUMMARY OF THE INVENTION

The present invention provides a picture display device that initializes the setting of a function without the need for a user being aware of such initialization.

One aspect of the present invention is a picture display device including a setting unit which enables a setting of a function related to the picture display device to be changed. The setting unit determines whether or not to initialize the setting of the function when power is switched between ON and OFF.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a diagram showing a state in which the enlargement of a picture cuts out part of the picture;

FIG. 2 is a diagram showing a state in which the enlargement of a picture cuts out part of a picture;

FIG. 3 is a schematic block diagram showing the structure of a television serving as a picture display device according to a first embodiment of the present invention;

FIG. 4 is a plan view showing a remote controller;

FIG. 5 is a flowchart showing the operation of the television of FIG. 3;

FIG. 6 is a flowchart showing the procedures for performing a commercial setting on the television of FIG. 3;

FIG. 7 is a front view showing a commercial setting menu screen on a display unit of the television of FIG. 3;

FIG. 8 is a front view showing a screen on the display unit for setting initialization under the commercial setting menu of FIG. 7;

FIG. 9 is a flowchart showing the procedures for initializing the setting of a function when the power is switched between ON and OFF; and

FIG. 10 is a schematic block diagram showing a structure of a television serving as a picture display device in accordance with a second embodiment of the present invention.

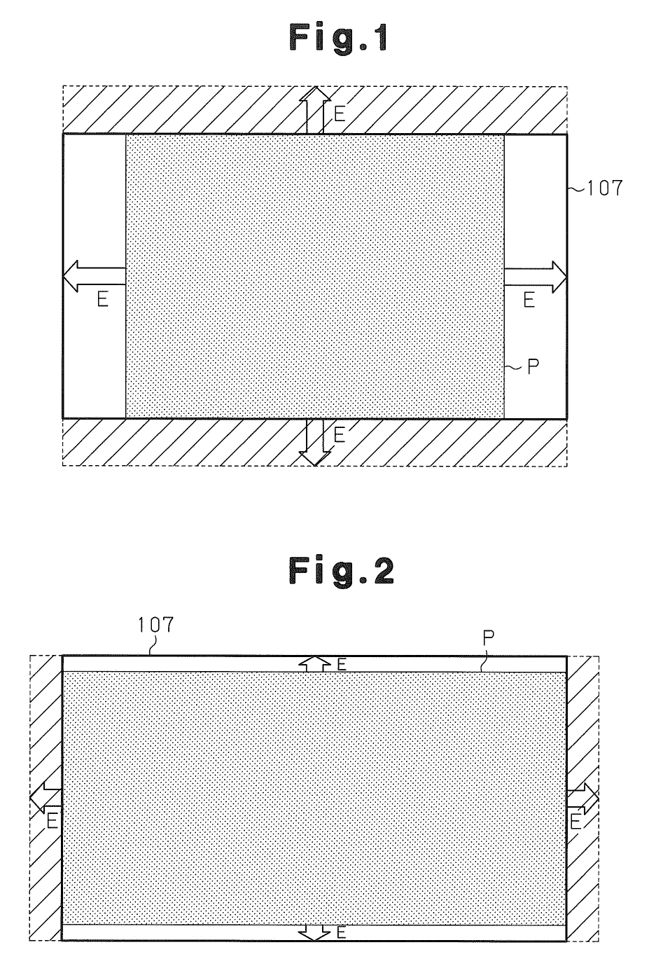

### DETAILED DESCRIPTION OF THE PREFERRED EMBODIMENTS

In the drawings, like numerals are used for like elements throughout.

A picture display device according to the present invention is embodied in a television having various types of functions, such as a function for adjusting the size of a picture. Specific embodiments of the present invention will now be discussed with reference to the drawings.

### First Embodiment

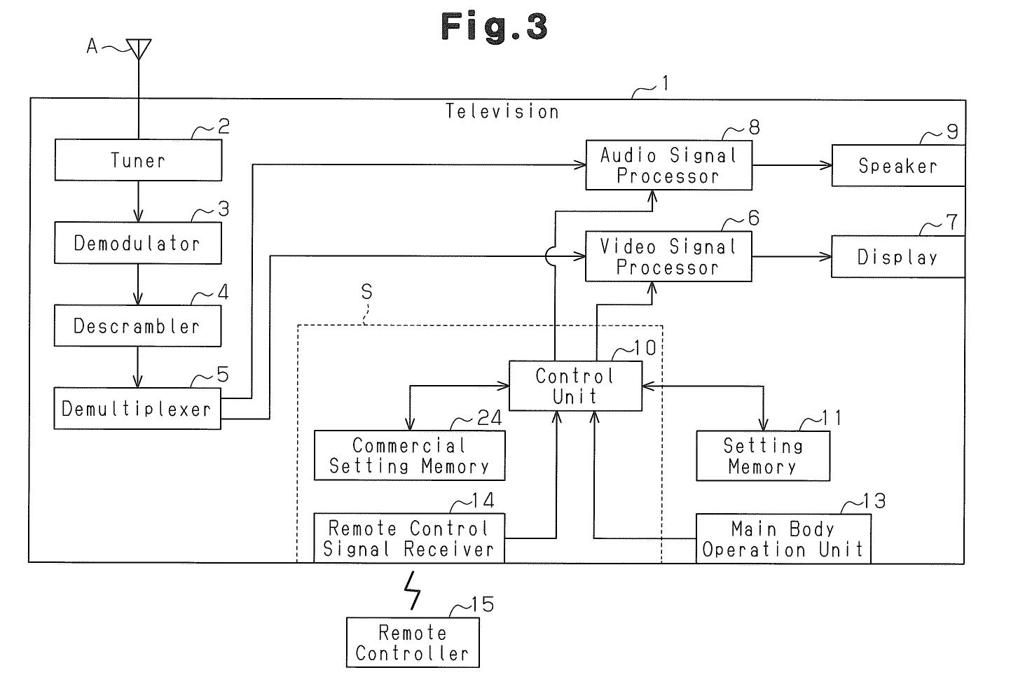

FIG. 3 is a schematic block diagram showing the structure of a picture display device according to a first embodiment of the present invention. As shown in FIG. 3, the television 1, which serves as a picture display device, receives broadcast signals. The television 1 shows pictures on a display 7, which serves as a display unit, based on picture information contained in the broadcast signals. Further, the television 1 reproduces sound from a speaker 9 based on audio information contained in the broadcast signals.

The television 1 includes a tuner 2 connected to an antenna A, which receives digital broadcast signals (hereinafter simply referred to as “broadcast signals”). A demodulator 3 demodulates signals output from the tuner 2 and performs error code correction. A descrambler 4 descrambles scrambled signals, which are demodulated by the demodulator 3.

The television 1 also includes a demultiplexer 5, which separates a descrambled signal into video data, audio data, and the like, a video signal processor 6, which performs signal processing on video signals, the display 7, an audio signal processor 8, which performs signal processing on audio signals, and the speaker 9.

The television 1 also includes a control unit 10, which controls each part of the television 1 (e.g., the tuner 2, video signal processor 6, and audio signal processor 8), a setting memory 11, a main body operation unit 13, and a remote control signal receiver 14.

The control unit 10 is a central processing unit (CPU) or a microcomputer that executes programs stored in a memory (not shown) and outputs control signals to the video signal processor 6 and the audio signal processor 8 to control each part of the television 1. For example, the control unit 10 sends a control signal to the video signal processor 6 to adjust the size of a picture shown on the display 7 based on a setting value stored in the setting memory 11. As a result, the video signal processor 6 adjusts the size of the picture and displays the picture on the display 7 with a size corresponding to the setting value.

Further, the control unit 10 includes an OSD signal generation circuit (not shown), which generates an OSD signal to display an on screen display (OSD) image. The OSD signal generated by the control unit 10 is sent to the video signal processor 6 so that a picture (i.e., OSD image) such as a setting menu is shown on the display 7 separately from the picture displayed based on the picture information contained in the broadcast signal.

The setting memory 11 is a writable and erasable non-volatile memory such as an EEPROM. To hold the setting of the function for adjusting the size of the picture even if the power is switched between ON and OFF, the setting memory 11 stores the setting value corresponding to the size of the picture. When manufactured and shipped out of a factory, an initial value for the setting value that is in correspondence with a picture size for entirely showing a picture in the display 7 is stored in the setting memory 11. When the size of the picture is adjusted (i.e., when the setting of the function for adjusting the size of the picture is changed), the control unit 10 stores the setting value corresponding to the adjusted size of the picture instead of the initial value in the setting memory 11.

The main body operation unit 13 includes a button (not shown) for switching the power of the television 1 between ON and OFF and a button (not shown) for switching channels. A signal corresponding to the operated button is sent from the main body operation unit 13 to the control unit 10. For instance, when the button for switching the power between ON and OFF for the television 1 is pushed, a signal indicating the switching of the power is sent. When the button for switching channels is pushed, a signal indicating the switching of channels is sent.

The remote control signal receiver 14 receives a signal (i.e., remote control signal) transmitted from a remote controller 15, which remotely operates the television 1. The remote control signal receiver 14 is an infrared receiving element for receiving the remote control signal transmitted by infrared rays. The signal received by the remote control signal receiver 14 is input to the control unit 10.

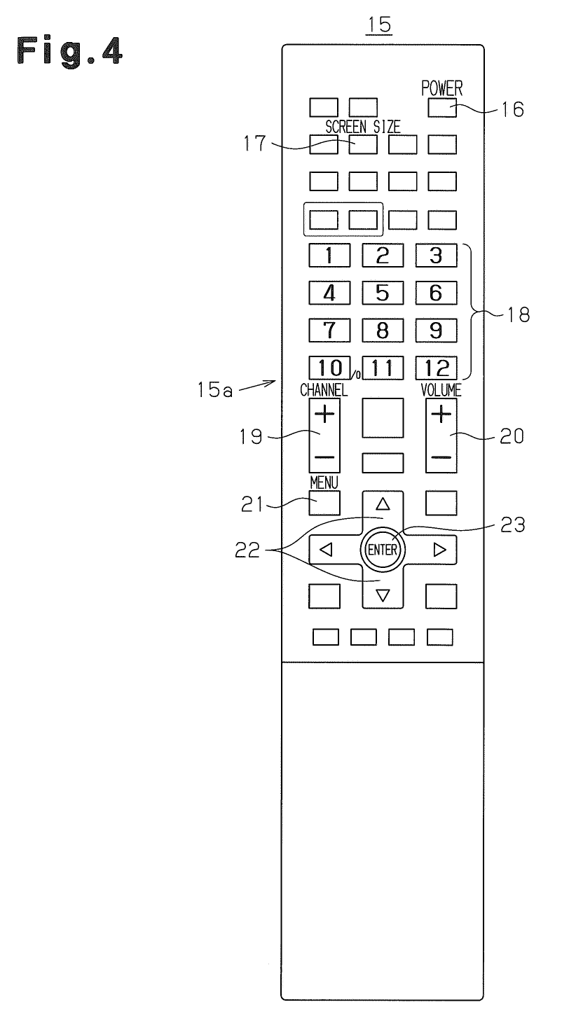

As shown in FIG. 4, the remote controller 15 includes an operation unit 15a operated by the user. The operation unit 15a includes buttons such as a power key 16, a screen size key 17, numerical keys 18, a channel key 19, a volume key 20, a menu key 21, a cursor movement key 22, and an enter key 23. When a button is operated, the remote controller 15 transmits a signal corresponding to the operated button to the remote control signal receiver 14. In other words, a signal indicating that the power has been switched ON or OFF is transmitted when the power key 16 is pushed, and a signal indicating the adjustment of the size of a picture shown on the display 7 is transmitted when the screen size key 17 is pushed. Furthermore, a signal indicating input numbers is transmitted when the numerical keys 18 are pushed, and a signal indicating the switching of channels is transmitted when the channel key 19 is pushed. A signal indicating adjustment of the volume of sound reproduced from the speaker 9 (audio output volume) is transmitted when the volume key 20 is pushed, and a signal for displaying a setting menu to start a normal setting is transmitted when the menu key 21 is pushed. A signal for selecting a setting item or setting content is transmitted when the cursor movement key 22 is pushed, and a signal determining the selected setting item or setting content is transmitted when the enter key 23 is pushed.

When receiving a signal from the main body operation unit 13 or the remote control signal receiver 14, the control unit 10 performs an operation corresponding to the input signal. For example, when the screen size key 17 is operated, the control unit 10 sends a control signal to the video signal processor 6 in order to adjust the size of a picture shown on the display 7. When the menu key 21 is operated, the control unit 10 sends an OSD signal to the video signal processor 6 in order to display the setting menu.

In this embodiment, the control unit 10 sends a control signal to the video signal processor 6 to adjust the size of a picture shown on the display 7. Thus, the television 1 has a function for adjusting the size of a displayed picture. The setting of this function may be changed by operating the screen size key 17 of the remote controller 15. That is, the setting of the function for adjusting the size of a picture is changed when the screen size key 17 is operated and a signal indicating adjustment of the size of a picture is sent to the control unit 10.

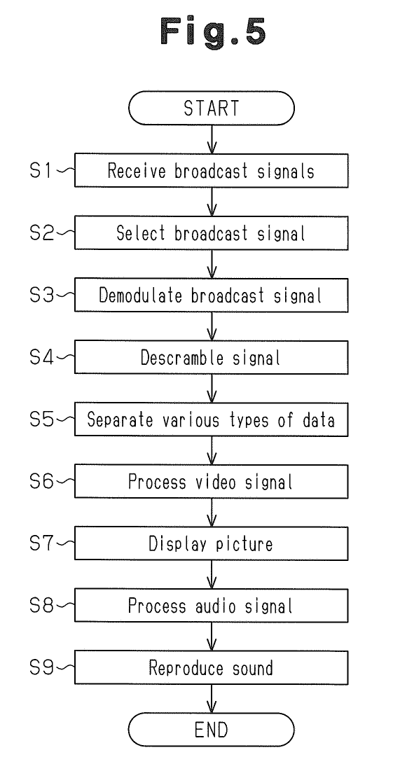

The operation of the television 1 to produce pictures on the display 7 and sound with the speaker 9 based on the video data and audio data contained in broadcast signals when the power of the television 1 is turned ON will now be discussed with reference to FIG. 5.

First, the antenna A receives a broadcast signal transmitted from a broadcast station. Then, the antenna A sends the received broadcast signal to the tuner 2 (step S1). The broadcast signal contains video data and audio data. For digital broadcasts, the video data and audio data are multiplexed in broadcast signals in compliance with MPEG-2 Systems.

From the broadcast signals received from the antenna A, the tuner 2 selects a broadcast signal that corresponds to the channel specified by the user and sends the selected broadcast signal to the demodulator 3 (step S2). In other words, the tuner 2 retrieves a broadcast signal of a specific frequency from the broadcast signals and sends the retrieved broadcast signal to the demodulator 3.

The demodulator 3 then A/D converts and demodulates the broadcast signal selected by the tuner 2 and performs error code correction for checking whether or not an error occurred in the transmission path. Then, the demodulator 3 outputs the demodulated, error code corrected signal to the descrambler 4 (step S3).

When the signal is scrambled, the descrambler 4 uses a descramble key stored in an IC card (not shown) to descramble the signal. The descrambler 4 then sends the non-scrambled signal in Transport Stream (TS) format to the demultiplexer 5 (step S4).

The demultiplexer 5 separates the video data, the audio data, and the like from the TS format signal. Then, the demultiplexer 5 sends the separated data to the video signal processor 6 and the audio signal processor 8 (step S5). More specifically, the separated video data is sent to the video signal processor 6 as a video signal, and the separated audio data is sent to the audio signal processor 8 as an audio signal.

The video signal processor 6 performs various types of signal processing on the video signal, which includes the video data (step S6). For instance, the video signal processor 6 decodes video data that is compression coded in the MPEG-2 Video format. When receiving the OSD signal, the video signal processor 6 combines the OSD signal with the video signal to show the OSD image on the display 7.

In step S6, when a control signal indicating adjustment of the size of a picture shown on the display 7 is received from the control unit 10, the video signal processor 6 performs signal processing on the video signal to adjusting the size of the picture. In other words, a scaling process, such as a process for enlarging a picture so that the width of the picture becomes the same as the width of the display 7 or a process for enlarging a picture so that the height of the picture becomes the same as the height of the display 7 is performed.

Then, the video signal that has undergone various types of signal processing in the video signal processor 6 is sent to the display 7. Based on the video signal, the display 7 displays a picture (step S7).

The audio signal processor 8 performs various types of signal processing on the audio signal, which includes the audio data (step S8). For instance, the audio signal processor 8 decodes audio data that is compression coded in the MPEG-2 AAC format. When a control signal for restricting the audio level (i.e., volume) is received, the audio signal processor 8 performs signal processing for lowering the volume of sound reproduced from the speaker 9 to be smaller than a predetermined volume.

The audio signal that has undergone signal processing in the audio signal processor 8 is sent to the speaker 9. Based on the audio signal, the speaker 9 reproduces sounds (step S9). Steps S6 and S7 are operations that may be performed in parallel with steps S8 and S9.

In this embodiment, the television 1 has a feature in which it includes a setting unit S used to set whether or not to initialize the setting of a function when the power is switched between ON and OFF. In one example, the setting unit S includes a commercial setting memory 24 that stores information on whether or not the setting of the function will be initialized. The control unit 10 determines whether or not to initialize the setting of the function based on the information stored in the commercial setting memory 24. The remote control signal receiver 14 receives a remote control signal that selects whether or not to initialize the setting of a function.

The commercial setting memory 24, which is a writable and erasable non-volatile memory such as an EEPROM, stores information on whether or not the setting of the function for adjusting the size of a picture will be initialized. Since the commercial setting memory 24 is a non-volatile memory, the setting content stored in the commercial setting memory 24 remains continuously stored even if the power of the television 1 is switched between ON and OFF. In other words, even if the power of the television 1 is switched between ON and OFF, the setting of whether or not the setting of a function will be initialized is held.

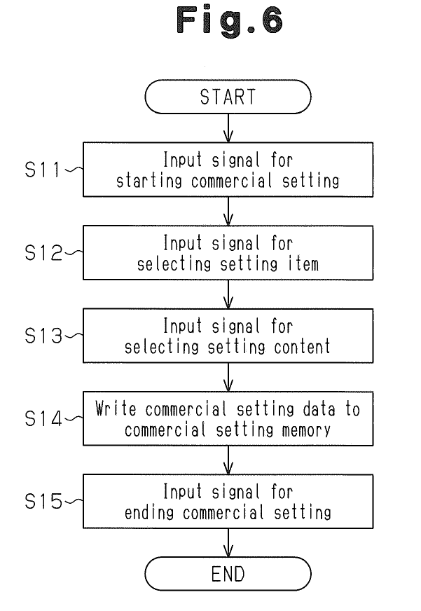

If the television 1 is used for commercial purposes and installed in a guest room of a lodging facility, the setting unit S sets whether or not the setting of a function will be initialized through the procedures shown in FIG. 6.

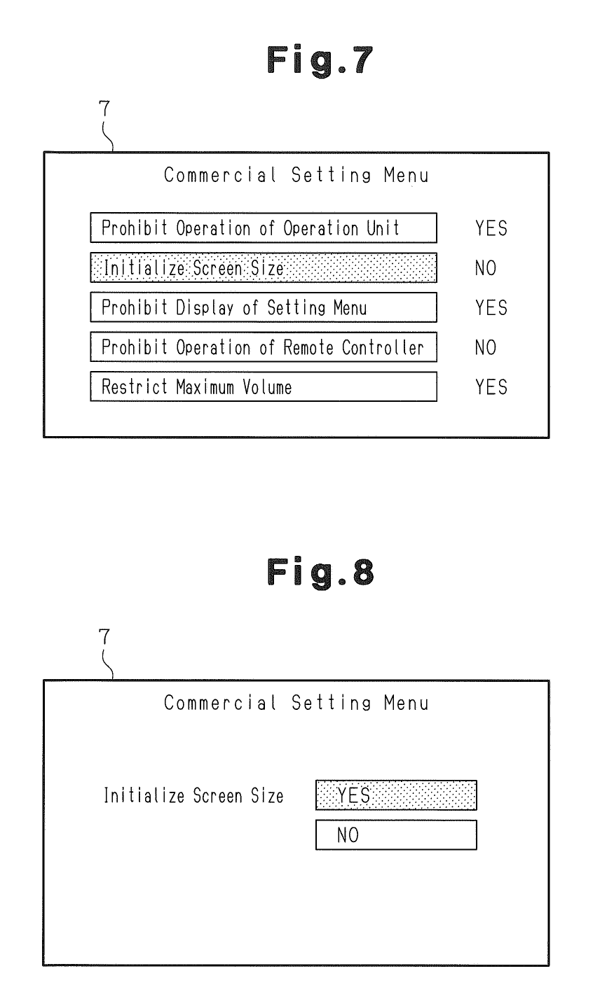

First, an employee or the like of the lodging facility who manages the television 1 operates the main body operation unit 13 or the operation unit 15a of the remote controller 15. This sends a signal for starting commercial setting to the control unit 10 (step S11). The operation for sending the signal starting the commercial setting to the control unit 10 is performed by, for example, simultaneously pushing a plurality of buttons. It is preferable that such operation be one that is normally not performed by a generally user. When receiving the signal for starting the commercial setting, the control unit 10 outputs an OSD signal to the video signal processor 6. As a result, a commercial setting menu, which is an OSD image as shown in FIG. 7, appears on the display 7 so that a setting item may be selected.

Then, a signal for selecting a setting item that is to be set is sent to the control unit 10 (step S12). That is, the employee or the like of the lodging facility operates the cursor movement key 22 and the enter key 23 of the remote controller 15 while referring to the commercial setting menu shown on the display 7 to select the setting item of “initialize screen size”. When receiving a signal indicating selection of the setting item, the control unit 10 sends an OSD signal to the video signal processor 6. As a result, a commercial setting menu, which is an OSD image as shown in FIG. 8, appears on the display 7 so that a setting content may be selected.

A signal indicating selection of a setting content is then sent to the control unit 10 (step S13). That is, the employee or the like of the lodging facility operates the cursor movement key 22 and the enter key 23 of the remote controller 15 while referring to the commercial setting menu shown on the display 7 to select either “YES” or “NO” as the setting content for “Initialize Screen Size”.

In step S13, if the user is a person who does not use the television 1 for more than two days (e.g., a guest who does not stay a successive number of days in the same guest room of the lodging facility), the setting content for “Initialize Screen Size” is set to “YES”, and the setting of the function is initialized when the power is switched between ON and OFF. If the user is a person who uses the television 1 for more than two days (e.g., a guest staying a successive number of days in the same guest room of the lodging facility), the setting content for “Initialize Screen Size” is set to “NO”, and the setting of the function is not initialized when the power is switched between ON and OFF.

The setting contents of “Initialize Screen Size”, which is information of whether or not the setting of the function for adjusting the size of a picture will be initialized, is written to the commercial setting memory 24 as commercial setting data (step S14). In other words, in step S14, the information of whether or not the setting of the function will be initialized is stored in the commercial setting memory 24.

A signal for ending the commercial setting is sent to the control unit 10 by operating the main body operation unit 13 or the operation unit 15a of the remote controller (step S15). Then, the control unit 10 outputs a control signal to the video signal processor 6 to eliminate the commercial setting menu, which is an OSD image, from the display 7.

The initialization may be set in the same manner through the procedures shown in FIG. 6 for the items of “Prohibit Operation of Main Body Operation Unit”, “Prohibit Display of Setting Menu”, “Prohibit Operation of Remote Controller”, and “Restrict Maximum Volume”. Thus, the initialization setting for these items will not be described in detail.

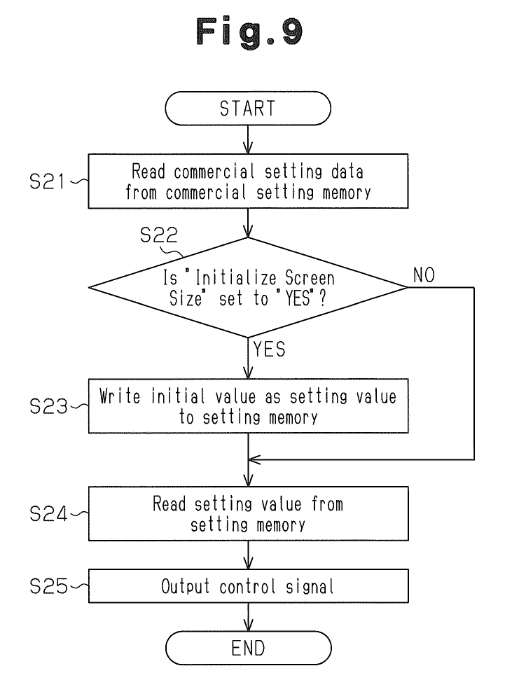

The procedures for initializing the setting of the function for adjusting the size of a picture when switching the power between ON and OFF for the television 1 in the guest room of the lodging facility (i.e., when the power of the television 1 is turned ON) will now be discussed with reference to FIG. 9.

When a user (i.e., guest) turns ON the power for the television 1, a signal indicating the switching of the power between ON and OFF is sent to the control unit 10. The control unit 10 first reads the commercial setting data stored in the commercial setting memory 24 (step S21). That is, in step S21, the control unit 10 retrieves the setting contents for “Prohibit Operation of Main Body Operation Unit”, “Initialize Screen Size”, “Prohibit Display of Setting Menu”, “Prohibit Operation of Remote Controller”, and “Restrict Maximum Volume” from the commercial setting memory 24.

The control unit 10 determines whether or not the setting content of “Initialize Screen Size” is set to “YES” based on the commercial setting data read out in step S21 (step S22). That is, in step S22, the control unit 10 determines whether or not to initialize the setting of the function based on the information stored in the commercial setting memory 24.

If the content of the setting for “Initialize Screen Size” is set to “YES”, the control unit 10 deletes the setting value that was stored in the setting memory 11 before the power was turned ON. Then, the control unit 10 writes and stores the initial value in the setting memory 11 as a setting value (step S23). In other words, the control unit 10 writes to the setting memory 11 the initial value that is stored in the program executed by the control unit 10 (i.e., the setting value for a picture size that entirely shows a picture in the display 7 stored in the setting memory 11 when the television 1 is manufactured and shipped out of a factory). As a result, the setting of the function for adjusting the size of the picture is initialized. Thus, the previous setting of the function that another user would not be aware of is cancelled. That is, the function for adjusting the size of a picture is initialized so that the entire picture is shown on the display 7.

The control unit 10 then reads the setting value stored in the setting memory 11 (step S24). Further, the control unit 10 sends a control signal to the video signal processor 6 to adjust the screen size based on the setting value read in step S24 (step S25).

In step S23, if the content of the setting for “Initialize Screen Size” is set to “YES”, the initial value is stored in the setting memory 11. Thus, in step S25, a control signal is sent to the video signal processor 6 to adjust the size of a picture shown on the display 7 to be the same as the size set when the television 1 is manufactured and shipped out of a factory.

If the content of the setting for “Initialize Screen Size” is set to “NO” (i.e., when determined that the content of the setting for “Initialize Screen Size” is not set to “YES” in step S22), step S23 is skipped. This holds the setting of the function and does not initialize the setting. Thus, the setting of the function remains in accordance with the user's preference even if the power is switched between ON and OFF. In this case, the control unit 10 reads the value that has been set and stored in the setting memory 11 before the power is turned ON. Therefore, a control signal is sent to the video signal processor 6 to adjust the size of a picture shown on the display 7 to the size that has been set before the power was turned OFF.

The control unit 10 activates various types of functions based on the commercial setting data read in step S21. That is, in step S21, the control unit 10 reads the commercial setting data to retrieve the contents for the settings of “Prohibit Operation of Main Body Operation Unit”, “Prohibit Display of Setting Menu”, “Prohibit Operation of Remote Controller”, and “Restrict Maximum Volume”, in addition to “Initialize Screen Size”. When the content of the setting for “Prohibit Operation of Main Body Operation Unit” is set to “YES”, the control unit 10 invalidates a signal input from the main body operation unit 13. When the content of the setting for “Prohibit Display of Setting Menu” is set to “YES”, the control unit 10 invalidates a signal from the control unit 10 for displaying the setting menu used for inputs. Furthermore, when the content of the setting for “Prohibit Operation of Remote Controller” is set to “YES”, the control unit 10 invalidates a signal input from the remote control signal receiver 14. When the content of the setting for “Restrict Maximum Volume” is set to “YES”, the control unit 10 sends a control signal to the audio signal processor 8 for restricting the volume of the sounds reproduced by the speaker 9.

The television 1 of this present embodiment has the advantages described below.

(1) The television 1 includes the setting unit S, which is for setting whether or not the setting of a function will be initialized when the power is switched between ON and OFF. For example, if a guest (i.e., user) using the television 1 will not stay in the guest room of a lodging facility for more than two successive days, the setting unit S is used to initialize the setting of the function when the power is switched between ON and OFF. Thus, the previous setting of the function that another user would not be aware of is cancelled. If the guest using the television 1 will stay in the guest room of a lodging facility for two or more successive days, the setting unit S does not initialize the setting of the function when the power is switched between ON and OFF. Thus, the setting of the function remains in accordance with the user's preference even if the power is switched between ON and OFF. Accordingly, the person managing the television 1 such as an employee of the lodging facility who knows the guests of the lodging facility sets whether or not the setting of the function will be initialized when the power is switched between ON and OFF so that the setting of the function is initialized in correspondence with the user and so that the setting of the function is initialized without the user being aware of this.

(2) Functions of which settings are initialized when the power is switched between ON and OFF include the function for adjusting the size of the picture. In this case, the setting of the function for adjusting the size of the picture is initialized when the power is switched between ON and OFF. In other words, initialization is performed so that a picture is entirely presented to a user without any cut out parts.

(3) In one example, the setting unit S includes the commercial setting memory 24, which stores information of whether or not to the setting of a function will be initialized, and the control unit 10, which determines whether or not to initialize the setting of the function based on the information stored in the commercial setting memory 24. Thus, the information of whether or not the setting of a function will be initialized is stored in advance in the commercial setting memory 24. This allows for automatic determination of whether or not to initialize the setting of a function.

(4) The setting unit S preferably includes the remote control signal receiver 14, which receives a remote control signal for selecting whether or not to initialize the setting of a function. This allows for easy setting of whether or not the setting of a function will be initialized when the power is switched between ON and OFF through remote operations.

(5) The television 1 includes the display 7, which displays the commercial setting menu for setting whether or not the setting of a function will be initialized. This allows for the user to easily set whether or not the setting of a function will be initialized when the power is switched between ON and OFF while referring to the commercial setting menu shown on the display 7.

### Second Embodiment

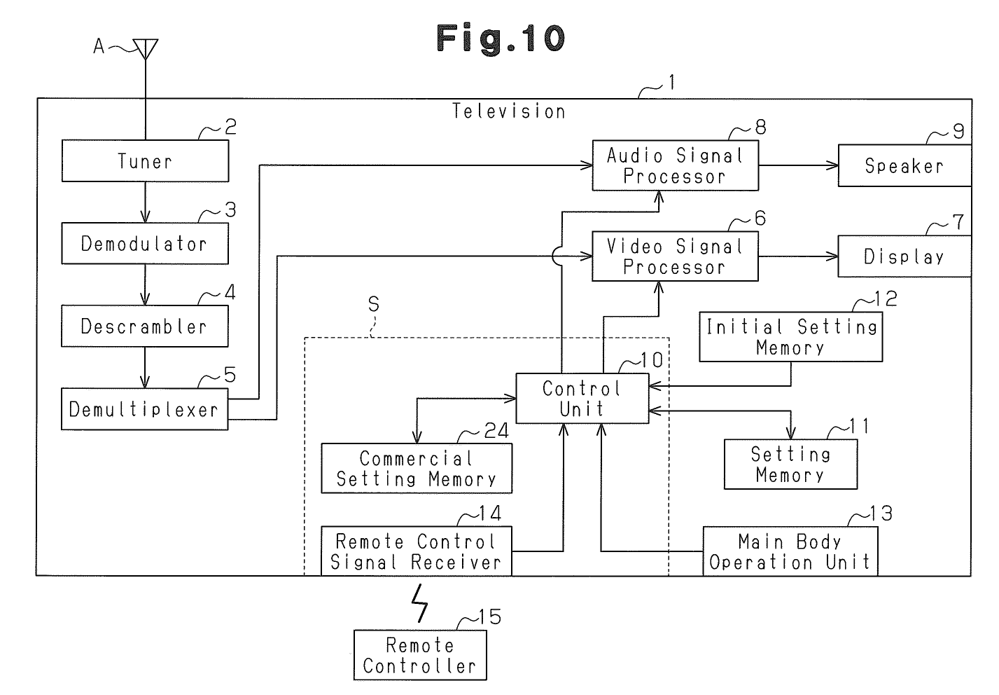

A picture display device according to a second embodiment of the present invention will now be discussed with reference to FIG. 10. FIG. 10 is a schematic block diagram showing the structure of the picture display device in the second embodiment of the present invention.

As shown in FIG. 10, the television 1, which serves as a picture display device in the second embodiment, additionally includes an initial setting memory 12. The initial setting memory 12 is a read-only non-volatile memory such as a mask ROM and stores an initial value, which is the setting value stored in advance in the setting memory 11 when the television 1 is manufactured and shipped out of a factory.

In the same manner as in the first embodiment, in the second embodiment, the setting for determining whether the setting of a function will be initialized is performed through the procedures shown in FIG. 6, and the initialization of the setting of the function for adjusting the size of a picture is performed through the procedures shown in FIG. 9.

In the second embodiment, in step S23 of FIG. 9, the control unit 10 writes in the setting memory 11 the initial value (setting value corresponding to the size of a picture when the picture is entirely shown in the display 7 and stored in advance in the setting memory 11 when the television is manufactured and shipped out of a factory), which is stored in advance in the initial setting memory 12. As a result, the setting of a function for adjusting the size of the picture is initialized so that the setting of the function that a user would not be aware of is cancelled. Therefore, in the same manner as the television 1 of the first embodiment, the television 1 of the second embodiment has advantages (1) to (5).

It should be apparent to those skilled in the art that the present invention may be embodied in many other specific forms without departing from the spirit or scope of the invention. Particularly, it should be understood that the present invention may be embodied in the following forms.

Components that that can be commonly shared may be integrated into a single unit. For example, the setting memory 11 and the commercial setting memory 24 may be formed by the same writable and erasable non-volatile memory. Further, the setting memory 11 and the initial setting memory 12 may be formed by the same writable and erasable non-volatile memory. Moreover, the setting memory 11, the initial setting memory 12, and the commercial setting memory 24 may be formed by the same writable and erasable non-volatile memory.

The commercial setting menu used to set whether or not the setting of a function will be initialized when the power is switched between ON and OFF does not have to be shown on the display 7. In this case, the setting unit S does not display a commercial setting menu and determines whether or not to initialize the setting of a function when the power is switched between ON and OFF in response to at least one setting operation. This obtains all of the above-described advantages except for advantage (5).

The setting unit S does not have to include the remote control signal receiver 14, which receives a remote control signal for selecting whether or not the setting of a function will be initialized. For instance, the signal for selecting whether or not the setting of a function will be initialized may be input to the control unit 10 by operating a button arranged on the main body operation unit 13. This obtains all of the above-described advantages except for advantage (4).

The function of which setting is initialized when the power is switched between ON and OFF is not limited to the function for adjusting the size of the picture. The function of which setting is initialized when the power is switched between ON and OFF may be a function for adjusting the image quality of the picture, a function for adjusting the volume of sound, and the like. This obtains all of the above-described advantages except for advantage (2).

The picture display device is the television 1 in the above embodiments but may be any device that displays a picture based on video information contained in video signals from an external device without receiving broadcast signals. In other words, the picture display device may be any device as long as it is a picture display device for displaying a picture in which the setting of a function may be changed.

The present examples and embodiments are to be considered as illustrative and not restrictive, and the invention is not to be limited to the details given herein, but may be modified within the scope and equivalence of the appended claims.

What is claimed is:

1. A picture display device comprising:
a setting unit which enables a setting of a function related to the picture display device to be changed, wherein the setting unit determines whether or not to initialize the setting of the function when power is switched between ON and OFF.

2. The picture display device according to claim 1, wherein the function of which setting is selectively initialized when the power is switched between ON and OFF includes a function for adjusting size of the picture.

3. The picture display device according to claim 1, wherein the function of which setting is selectively initialized when the power is switched between ON and OFF includes a function for adjusting image quality of a picture or a function for adjusting volume of an audio output.

4. The picture display device according to claim 1, wherein the function of which setting is selectively initialized when the power is switched between ON and OFF includes a function for prohibiting operation of the picture display device.

5. The picture display device according to claim 4, wherein the operation of the picture display device includes at least one of operation of an operation unit arranged on the picture display device and operation of a remote controller which remotely operates the picture display device.

6. The picture display device according to claim 1, wherein the setting unit determines whether or not to initialize the setting of the function in response to at least one setting operation.

7. The picture display device according to claim 1, wherein the setting unit includes:
a setting memory which stores information of whether or not to initialize the setting of the function; and
a control unit which determines whether or not to initialize the setting of the function based on the information stored in the setting memory.

8. The picture display device according to claim 7, wherein the control unit determines whether or not to initialize the setting of the function when reading the information from the setting memory.

9. The picture display device according to claim 8, wherein the control unit reads the information from the setting memory when turning ON the power of the picture display device.

10. The picture display device according to claim 9, wherein the control unit holds a setting value of the function set before the power is turned ON when the information read out from the setting memory does not indicate initialization of the setting of the function.

11. The picture display device according to claim 1, wherein the setting unit further includes a remote control signal receiver which receives a remote control signal that selects whether or not to initialize the setting of the function.

12. The picture display device according to claim 1, further comprising:
a display which displays a commercial setting menu for setting whether or not to initialize the setting of the function.
